(19) United States
(12) Patent Application Publication
(10) Pub. No.: US 2017/0017947 A1
(43) Pub. Date: Jan. 19, 2017

(54) TRUSTED NFC TICKETING

(71) Applicant: ASSA ABLOY AB, Stockholm (SE)

(72) Inventors: MARK ROBINTON, Eden Prairie, MN (US); FREDRIK WÄHL, Rockneby (SE)

(73) Assignee: ASSA ABLOY AB, Stockholm (SE)

(21) Appl. No.: 15/210,054

(22) Filed: Jul. 14, 2016

Related U.S. Application Data
(60) Provisional application No. 62/192,089, filed on Jul. 14, 2015.

(51) Int. Cl. G06Q 20/20; G06Q 20/32; G06Q 20/04; H04W 12/06; G06Q 20/40

(52) U.S. Cl. CPC G06Q 20/209; H04W 12/06; G06Q 20/40; G06Q 20/0453; G06Q 20/327

(57) ABSTRACT

A system is disclosed along with a method for operating the system. In one non-limiting embodiment, the disclosed ticketing system employs a trusted tag service, which enables a customer to safely load ticketing credit onto their mobile device and provide a proof of purchase via the mobile device. The ticketing system is also disclosed as including a transport operator application that can interface with the customer's mobile device to verify payment for a journey.

### CROSS-REFERENCE TO TO RELATED APPLICATIONS

The present application claims the benefit of and priority, under 35 U.S.C. §119(e). to U.S. Provisional Application Ser. No. 62/192,089, filed on Jul. 14, 2015, entitled “Trusted NFC Transport Ticketing,” the entire disclosure of which is hereby incorporated by reference, in its entirety, for all that it teaches and for all purposes

### FIELD

The present disclosure is generally directed to using trusted tags to facilitate the purchase of goods and services via a mobile device.

### BACKGROUND

The utilization of presence information has become increasingly important in commerce. Specifically, there are many technologies that attempt to utilize information about a person's presence or a thing's presence to provide or improve a service in connection therewith. As some examples, presence-based advertising, presence-based authentication, presence-based customer service, and the like are increasingly used

Current methods of interacting with tags (e g. Near Field Communications (NFC) tags. Bluetooth tags, RFID tags, etc) have a limitation where the interaction, typically reading a Universal Resource Locator (URL) from the tag, does not prove that there was a unique interaction with the tag. Whether the data on the tag is copied to another tag, or replayed, the data cannot be distinguished from an actual subsequent read (second tap) of the tag Accordingly, any technology that attempts to use a person's presence or a thing's presence via the person's or thing's interaction with a tag cannot be trusted since the tag data may be received as a copy or replay of an original interaction with a tag.

Additionally, in many public transport ticketing systems. Radio Frequency Identification (RFID) cards are used to validate that a passenger has paid for his or her journey. The passenger presents the card to a ticket validator that will either unlock the turnstile or give a green light for the driver/conductor if the card carries a sufficient pre-loaded amount of money or otherwise indicates that the passenger is authorized to enter the bus or other public transportation vehicle.

### SUMMARY

Public transport ticketing systems known in the art require a substantial amount of hardware such as special validators (e.g., machines to add value to your card), handheld readers for conductors, special turnstile devices, etc. All of this hardware naturally requires maintenance and can lead to a standstill of the entire system should the equipment break down.

Embodiments of the present disclosure can, to a large extent, replace the above equipment and simplify operations for operator and passenger.

Current transport ticketing systems are a substantial investment for public transport operators. Tendering for, purchasing, installing, maintaining, and servicing the ticketing system and distributing PVC cards for use therewith requires substantial expense. If machines come to standstill, they cannot sell tickets to passengers or charge passengers for the journey. Many transport systems still use, to date, a ‘traditional’ ticket whereas other service providers (banks, etc.) have progressed much more in mobile device integration and use.

Passengers, meanwhile, are forced to use a plastic card and to find a ‘top up’ machine to load the card with sufficient money or credit before starting a journey.

Embodiments of the present disclosure propose a system utilizing HID's Trusted Tag® Services, or similar services, in combination with an application for use on a mobile device (e.g., smartphone). Details of Trusted Tag® Services are further described in PCT Publication No. 2014/140818, filed Dec. 4, 2014, as well as U.S. Provisional Patent Application Nos. 61/794,371 and 61/794,447, both filed on Mar. 15, 2013, each of which is hereby incorporated herein by reference in its entirety. The terms trusted tag and smart tag are used synonymously herein.

In particular, PCT Publication No. 2014/140818 describes systems and methods for providing the ability to validate that a smart tag has, in fact, been uniquely read (e.g., physically tapped), which proves the user is in the presence of the tag. According to embodiments of the present disclosure, it should be possible in some cases to validate locally (e.g., at the point of tap) that the tap is unique. In other cases, a remote authentication service can be used to validate that the tap is unique. Thus, proof of presence can be determined either locally at the point of tag interaction or remotely with a remote authentication service.

PCT Publication No. 2014/140818 also discloses a smart tag with the ability to generate a pseudo-random sequence of numbers that can be appended to the tag's response, such as a URL, email address, phone number, etc. The validation of this pseudo-random sequence of numbers can be done by a validation engine which tracks the sequence for each tag and indicates if the tag has generated the next number in the sequence indicating the user has, in fact, interacted with the tag and is, therefore, currently in the presence of the tag. This information can be used to correlate the user's location to a known location of the tag.

Further, PCT Publication No. 2014/140818 discloses a mobile device, such as a smartphone, with an application that maintains a local database of the tag interactions that have occurred at the mobile device. Each time a Tag Unique Identifier (TAGID) is read from a smart tag, a counter is also read from the tag. Based on the information contained in a tag response (e.g., a TAGID and counter value), the local application can determine whether the tag response was a unique response or a replay. In particular, the local application can compare the TAGID and counter value against TAGID/counter value combinations contained in its local database of tag interactions to determine whether the TAGID/counter value combination currently received from the tag is contained in the local database. If the TAGID/counter value combination is not in the local database, then the application can determine that the tag response is a unique response and the location of the mobile device can be correlated to the known location of the tag. In a variation of this implementation, the database of tag interactions could be maintained at a remote authentication service. In this variation, the mobile device may send the entire tag response (e.g., the response including the TAGID and counter value) to the authentication service for analysis.

Still further, PCT Publication No. 2014/140818 discloses that a mobile device may be required to verify that it is interacting with a previously determined (and authorized) smart tag at a known location. In this embodiment, the location of the tag could be known and fixed and the mobile device may also provide its location information (e.g., GPS location information, WiFi-based location information, cellular triangulation location information, etc.) to an authentication service. Before the mobile device begins interacting with a tag, the mobile device may be provided with a challenge/response pair issued by an authentication service. This challenge/response pair may be formatted specifically based on the location information provided by the mobile device. Specifically, the authentication service may attempt to identify a tag that has a location closer to the mobile device location than any other deployed tag. The mobile device may then issue a challenge to the tag (e.g., based on information contained in the challenge/response pair received from the authentication service). The tag may respond to the challenge with a response. If the response received from the tag matches the expected response contained in the challenge/response pair, then the mobile device can confirm that it is interacting with an approved tag based on its location and further interactions with the tag will be allowed.

Returning to the topic of transportation, and given the drawbacks of current transportation ticketing systems described above, when Trusted Tag® Services are used in combination with an application for a transport operator, it becomes possible to enable the commuter to check-in by tapping a trusted tag with his or her mobile device (e.g., cellular phone, smartphone, etc.), which creates a receipt (e.g. a proof-of-purchase) for the journey via the application loaded on the mobile device. This receipt can be displayed via a User Interface (UI) (which may be, for example, a graphical user interface, such as a screen or a touchscreen) of the mobile device to a vehicle operator or operator's representative (e.g. a bus driver, a train conductor, a ferry stewardess, or a flight attendant) on entry, or to security personnel (e.g. to a U.S. Transportation Security Administration security officer). The receipt can also be stored for inspection at a later time.

As used herein, a mobile device may be a smartphone, a tablet, or any other device comprising a processor, a data storage capability (e.g., computer memory), and a wireless communication capability. A user is an individual in authorized possession of a mobile device, who uses the mobile device in conjunction with a trusted tag in accordance with the systems and methods disclosed herein.

The terms “memory,” “computer memory,” and “computer-readable medium,” as used herein, refer to any tangible data storage medium that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, a hard disk, a magnetic tape or any other magnetic medium, a magneto-optical medium, a CD-ROM, any other optical medium, punch cards, paper tape, any other physical medium with patterns of holes, a RAM, a PROM, an EPROM, a FLASH-EPROM, a solid state medium like a memory card, any other memory chip or cartridge, or any other medium from which a computer can read instructions. When the computer-readable medium is configured as part of a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

The term “a” or “an” entity refers to one or more of that entity. As such, the terms “a”, “an”, “one or more” and “at least one” can be used interchangeably herein. It is also to be noted that the terms “comprising”, “including”, and “having” can be used interchangeably.

The terms “determine,” “calculate,” and “compute,” and variations thereof, as used herein, are used interchangeably and include any type of methodology, process, mathematical operation, or technique.

The term “means” as used herein shall be given its broadest possible interpretation in accordance with 35 U.S.C., Section 112, Paragraph (f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The term “module” as used herein refers to any known or later developed hardware, software, firmware, artificial intelligence, fuzzy logic, or combination of hardware and software that is capable of performing the functionality associated with that element.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a block diagram depicting a communication system in accordance with embodiments of the present disclosure;

FIG. 2 is a diagram depicting a first method of determining presence in accordance with embodiments of the present disclosure;

FIG. 3 is a diagram depicting a second method of determining presence in accordance with embodiments of the present disclosure;

FIG. 4 is a diagram depicting a third method of determining presence in accordance with embodiments of the present disclosure; and

FIG. 5 is a diagram depicting a fourth method of determining presence in accordance with embodiments of the present disclosure.

FIG. 6 is a block diagram depicting aspects of a communication system in accordance with at least one embodiment of the present disclosure;

FIG. 7 is a flowchart depicting a method of utilizing a trusted tag in accordance with at least one embodiment of the present disclosure; and

FIG. 8 is a flowchart depicting another method of utilizing a trusted tag in accordance with at least one embodiment of the present disclosure.

### DETAILED DESCRIPTION

Copyright and Legal Notices

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

According to one embodiment of the present disclosure, a system comprises a mobile device operated by a user and a trusted tag. The trusted tag comprises memory that stores service or goods information describing a service or good with which the trusted tag is associated and a wireless interface that enables the trusted tag to communicate the service or goods information to the mobile device such that the mobile device is allowed to conduct a transaction using the service or goods information and obtain a proof-of-purchase for the service or good with which the trusted tag is associated.

The system may also comprise a service or goods application stored on the mobile device that enables the mobile device to retrieve the service or goods information from the trusted tag and, based on the service or goods information, exchange pre-purchased credit obtained by the user for services or goods offered by a vendor. The service or goods application may perform an authentication with the trusted tag prior to the trusted tag providing the service or goods information to the mobile device. The service or goods application may require the user to provide a confirmation of intent to complete the transaction prior to exchanging the pre-purchased credit for the services or goods offered by the vendor. The confirmation of intent may comprise moving the mobile device is a particular manner, such as at least one rotation or predetermined sequence of motions of the mobile device. At least one rotation or predetermined sequence of motions may be sensed by the mobile device with an accelerometer provided on the mobile device.

In some embodiments, rather than using pre-purchased credit for the transaction, the user may enter credit card information or other payment information directly into the service or goods application. The mobile device may generate, after conducting the transaction with respect to the service or goods information, a receipt to provide the proof-of purchase. The receipt may be visually displayed via a user interface of the mobile device. The receipt may be stored in a memory of the mobile device.

According to another embodiment of the present disclosure, a method of facilitating transactions and providing a proof-of-purchase for transactions comprises presenting a mobile device to a trusted tag such that the mobile device and trusted tag are within a wireless communication range of one another; receiving, at the mobile device, service or goods information from the trusted tag, wherein the service or goods information describes a service or good with which the trusted tag is associated; and, based on the service or goods information, determining whether the user of the mobile device has sufficient credit in an associated account to cover the service or goods associated with the trusted tag. The credit may be tracked, stored, or otherwise associated with a vendor account (e.g. a user account with a vendor), with a broker account (e.g. a user account with a broker, such that the credit associated with the broker account may be used to purchase goods or services from more than one vendor) or otherwise stored in the memory of the mobile device.

The method may further comprise exchanging at least some of the credit in the account for the service or goods with which the trusted tag is associated. The method may also further comprise generating, after the exchanging, a receipt that constitutes proof-of-purchase of the service or goods with which the trusted tag is associated. The receipt may be displayed on a user interface of the mobile device. The receipt may also be stored in a memory of the mobile device. The method may yet further comprise displaying a request for confirmation to exchange at least some of the credit in the account for the service or goods with which the trusted tag is associated; and receiving a confirmation input in response to the request. The confirmation input may comprise a predetermined motion detected by an accelerometer of the mobile device.

According to yet another embodiment of the present disclosure, a mobile device may comprise a graphical user interface; a network interface; a near-field communication reader for communicating with a trusted tag; a processor; and a memory storing a transport operator application. The transport operator application may comprise instructions for execution by the processor that, when executed by the processor, cause the processor to: detect a trusted tag; authenticate the trusted tag using authentication information received from the trusted tag; receive trip information from the trusted tag, the trip information corresponding to a trip for which access may be purchased; display, on the graphical user interface, a confirmation request; receive a confirmation input; in response to the confirmation input, transmit a purchase request to exchange pre-purchased credit for access to the trip; receive, in response to the purchase request, a purchase receipt; and display the purchase receipt on the graphical user interface. Access may be via a ticket or other accepted form.

The mobile device may further comprise an accelerometer, and the confirmation input may further comprise a predetermined motion detected by the accelerometer. Additionally, the trip information may comprise a cost of access to the trip, and the transport operator application may comprise additional instructions that, when executed by the processor, further cause the processor to compare the cost of the access with an available amount of pre-purchased credit.

Before any embodiments of the disclosure are explained in greater detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

Embodiments of the present disclosure will be described in connection with interactions between a smart tag and a mobile device. While most of the embodiments describe a mobile device, it should be appreciated that embodiments of the present disclosure are not so limited. Indeed, any type of device having a processor and memory capable of performing the functions of the smart tag discussed herein can be utilized without departing from the scope of the present disclosure. For instance, any tag form factor may be used. Examples of such form factors include card-type tags, key fobs, wristbands, smart tags embedded in clothing or other objects, smart watches, stickers, smart phones, laptops, tablets, etc. Furthermore, the mobile device may correspond to a mobile device carried by a user (e.g., to determine a presence or location of a user) or it may be associated with an inanimate object or thing (e.g., to determine a presence or location of a thing). Thus, while embodiments of the present disclosure are described in connection with determining presence information for a user or person, it should be appreciated that embodiments of the present disclosure are not so limited.

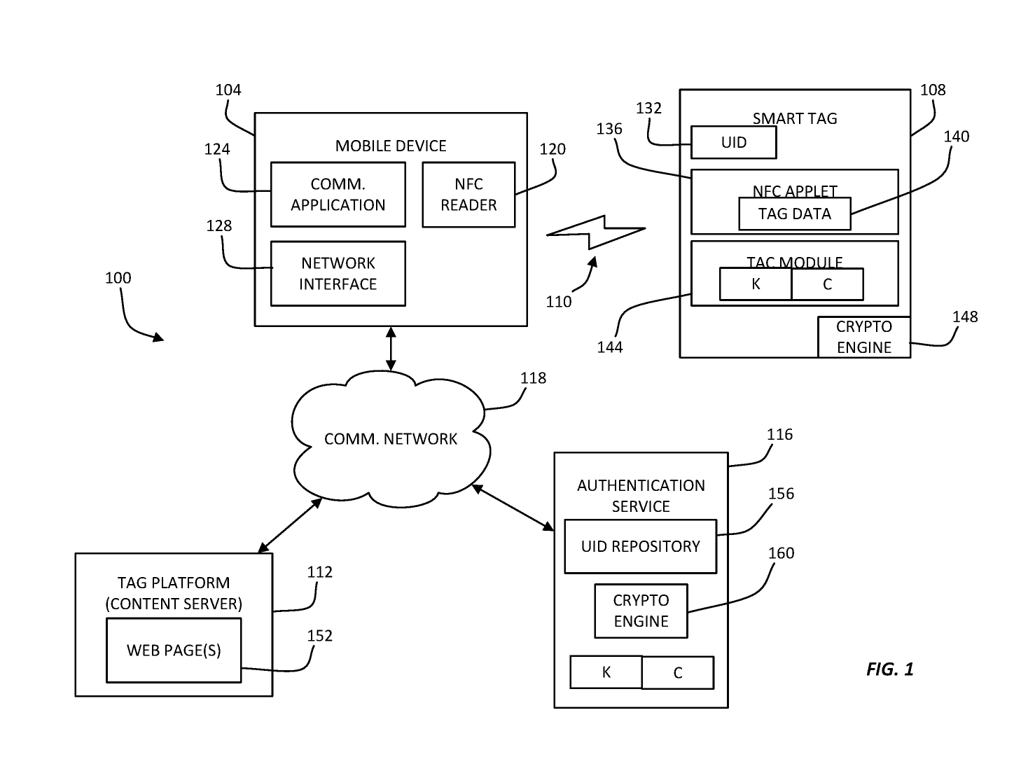

With reference initially to FIG. 1, a communication system 100 will be described in accordance with at least some embodiments of the present disclosure. The communication system 100 is shown to include a mobile device 104, a smart tag 108, a tag platform 112, and an authentication service 116, each of which is interconnected or in communication with one another via one or more communication networks 118.

In some embodiments, the mobile device 104 corresponds to a mobile communications device, such as a smartphone or the like. In more specific embodiments, the mobile device 104 may correspond to an NFC-enabled communications device in that the mobile device 104 may be configured to exchange communications with the smart tag 108 via NFC. As shown in FIG. 1, a communications channel 110 may be established directly between the mobile device 104 and the smart tag 108 to enable communications there between. In some embodiments, this communications channel 110 corresponds to an NFC or non-galvanic mutual coupling between the mobile device 104 and smart tag 108. In other embodiments, the communications channel 110 corresponds to a direct or indirect wireless communications channel, examples of which may include a Bluetooth channel (e.g., a direct wireless channel), a WiFi/IEEE 802.11N channel (e.g., an indirect channel through a wireless router), etc. In some embodiments, the type of channel 110 used to communicate between the mobile device 104 and smart tag 108 may depend upon the capabilities of the devices; thus, although embodiments of the present disclosure will be described in connection with NFC readers and applets, it should be appreciated that embodiments of the present disclosure are not so limited. Instead, embodiments of the present disclosure contemplate the utilization of a Bluetooth, WiFi, optical, any other type of RF protocols such as ZigBee, Zwave, etc., and/or sound based communication channel 110 between the mobile device 104 and smart tag 108.

As depicted in FIG. 1, the mobile device 104 may comprise an NFC reader 120, a communication application 124, and a network interface 128, among other things. Examples of a mobile device 104 include, without limitation, a smartphone, a tablet, a laptop, a Personal Digital Assistant (PDA), a smart watch, a remote control, a smart vehicle or car, or the like. Although not depicted, the mobile device 104 may also comprise one or more processors (e.g., microprocessors, CPUs, etc.) that are configured to perform certain operations for the mobile device 104 and memory for storing the instructions that are executable by the one or more processors. As an example, the mobile device 104 may have dedicated processors for its NFC functions, communication functions, and other functions (e.g., image-capture functions, GPS functions, etc.). In some embodiments, the components of the mobile device 104 may be connected together via a data bus or similar architecture. The memory of the mobile device 104 may be volatile and/or non-volatile.

The NFC reader 120 may correspond to a collection of components that enable the mobile device 104 to communicate via the communications channel 110 with the smart tag 108. Types of components that may be provided as part of the NFC reader 120 may be executed by a processor of the mobile device 104 to enable the mobile device 104 to operate in one or more of a card emulation mode, a read/write mode, and/or a peer-to-peer mode of operation. In some embodiments, the NFC reader 120 may also comprise a secure element such as a SIM card or an embedded secure element, where NFC data is stored and/or processed in an encrypted or secure fashion.

As noted above, the mobile device 104 may establish the communications channel 110 via non-NFC methods. Thus, the mobile device 104 may also include non-NFC communication components (e.g., Bluetooth antennas, Bluetooth drivers, WiFi antennas, Ultra-High Frequency (UHF) communication components, High Frequency (HF) communication components, any variation of Bluetooth components (e.g., drivers or antennas that support Bluetooth, Bluetooth 4, Bluetooth Low Energy (BLE)), ZigBee components, etc.). Furthermore, the non-NFC communications with the smart tag 108 may occur via the network interface 128 and/or the antenna of the NFC reader 120.

The communication application 124 may correspond to one or more of a phone module, email module, Internet browser, messaging module (e.g., SMS, MMS, etc.), or the like that enables the mobile device 104 to communicate with other communication devices via the communication network 118. Another type of communication that may be facilitated by the communication application 124 includes social networking communications. [what about Trusted Tag app?]

The network interface 128 may comprise one or more different networks or network types. For instance, the network interface 128 may comprise a cellular network interface that enables the mobile device 104 to interact with a cellular network, which is usually provided by a Mobile Network Operator (MNO). Alternatively, or additionally, the network interface 128 may comprise a Bluetooth interface, Infrared interface, etc. The network interface 128 may alternatively or additionally include an 802.11N interface (e.g., Wi-Fi interface), a Universal Serial Bus (USB) port, or any other wired or wireless interface to the communication bus of the mobile device 104.

The smart tag 108 may correspond to any type of device with memory, a processor, and one or more antennas to communicate via the communications channel 110. Non-limiting examples of form factors for the smart tag 108 may include card-type tags, key fobs, wristbands, smart tags embedded in clothing or other objects, smart watches, stickers, smart phones, laptops, tablets, etc. In some embodiments, the smart tag 108 may comprise data storage in the form of a volatile or non-volatile memory as well as a microprocessor or Integrated Circuit (IC). In some embodiments, the smart tag 108 may comprise an Integrated Circuit Card (ICC).

Components of the smart tag 108 are depicted as including a TAGID 132, an NFC applet 136, a Tag Authentication Cryptogram (TAC) module 144, and a cryptographic engine 148, some or all of which may be stored in a secure area of the smart tag's 108 memory [add memory to drawing?]. The TAGID 132 of the smart tag 108 may correspond to a static or dynamically-changing string (e.g., alphanumeric string, series of bits, etc.) that identifies the smart tag 108 in a globally unique fashion. As a more specific example, the TAGID 132 may correspond to an identification number assigned to and stored by the smart tag 108 that is uniquely assigned to the smart tag 108 (e.g., to the exclusion of being assigned to any other similar type of smart tag 108).

The NFC applet 136 may correspond to a set of instructions stored on the smart tag 108 that enable the smart tag 108 to generate and share tag data 140 with a mobile device 104 via the communications channel 110. More specifically, the NFC applet 136 may enable the smart tag 108 to receive and understand read requests issued by the mobile device 104 and then respond to the read request in a substantially unique way. In some embodiments, when the smart tag 108 receives a read request from a mobile device 104, the smart tag 108 may invoke its NFC applet 136, which subsequently invokes the TAC module 144. The NFC applet 136 may correspond to an application or portion of executable code that enables the smart tag 108 to emulate functionality of an NFC tag, perhaps in accordance with ISO 7816, the entire contents of which are hereby incorporated herein by reference. The TAC module 144 may correspond to code contained within the smart tag 108 (and possibly written thereto during provisioning) that is capable of generating unique responses to read requests on behalf of the smart tag 108. In some embodiments, the TAC module 144 may comprise a unique cryptographic key K and a counter value C and the TAC module 144 may utilize the cryptographic key K and counter value C along with the assistance of a cryptographic engine 148 to create a data object that can be provided back to the mobile device 104 in response to a read request. Examples of TACs that may be generated by the TAC module 144 include, without limitation, a One-Time-Password (OTP), a pseudo-random number, a counter value, or combinations thereof.

In some embodiments, the cryptographic key K may correspond to a symmetric encryption key of length N bytes that is substantially unique to the smart tag 108 on which it is written. In some embodiments, the cryptographic key K may correspond to at least some of the unique seed value written to the smart tag 108 during provisioning. Likewise, the counter value C may also correspond to a random initial value assigned to the smart tag 108 during provisioning or any incremented value obtained as the smart tag 108 generates responses to devices. In other words, the counter value C may change according to use of the smart tag 108 such that the counter value C is never the same value twice during the life of the smart tag 108; thereby ensuring that the smart tag 108 continues to generate substantially unique responses to each read request. Thus, the unique seed value may correspond to the combination of the cryptographic key K and the counter value C initially written to the smart tag 108 during provisioning.

In other embodiments, the counter value C may correspond to a changeable data part that is not necessarily incremented after each use by the smart tag 108. Instead, the counter value C may correspond to a pseudo-randomly generated value that is computed each time the smart tag 108 is preparing a response. Thus, the counter value C may actually correspond to the output of a pseudo-random number generator as opposed to a value that increments by a predetermined amount (e.g., one, two, three, . . . , ten, etc.) after each use. In either event, the counter value C is intended to change and be substantially unique on a per-transaction basis.

The cryptographic engine 148 is designed to compute a TAC, once invoked by the TAC module 144, based on inputs K and C provided by the TAC module 144. Even more specifically, when the TAC module 144 is invoked by the NFC applet 136, the TAC module 144 may provide the cryptographic key K and the current counter value C (or pseudo-randomly-generated number) to the cryptographic engine 148 which utilizes a cryptographic mechanism that is a hash function that takes an arbitrary block of data (e.g., K and C) and returns a fixed-size bit string, the cryptographic hash value, such that any (accidental or intentional) change to the data will (with very high probability) change the output hash value. Non-limiting examples of cryptographic mechanisms that may be used as the cryptographic engine 148 include MD5, SHA-1, SHA-2, SHA-3, SHA-256, keyed-hash message authentication codes (HMACs), or any other 128, 256, or 512-bit encryption algorithm. The cryptographic engine 148 returns a value based on the inputs K and C that is provided to the NFC applet 136.

In some embodiments, a smart tag 108 may be configured to generate a TAC in response to any number of conditions or triggers. As one example, the smart tag 108 may generate a TAC in response to a mobile device 104 coming into a predetermined proximity (e.g., a read range) of the smart tag 108. In this particular configuration, the smart tag 108 may automatically generate a TAC every time that a mobile device 104 comes within a distance suitable to establish a bidirectional communication link with the smart tag 108. Thus, a new TAC may be automatically generated by the smart tag 108 in response to detecting a mobile device 104 within its communication range, regardless of whether or not the mobile device 104 requests information from the smart tag 108. This means that a certain number of TACs generated by the smart tag 108 may never be transmitted to a mobile device 104; instead, the smart tag 108 will increment or move on to the next TAC when another (or the same mobile device 104) mobile device 104 comes into read range of the smart tag 108 (or the same mobile device 104 exits and re-enters the read range). As another example, the smart tag 108 may be triggered to generate a TAC only in response to receiving a request for authentication from the mobile device 104. In this configuration, the smart tag 108 may wait to generate a TAC unless and until a mobile device 104 is within a read range of the smart tag 108 and the mobile device 104 requests that the smart tag 108 authenticate itself to the mobile device 104. After the request for authentication is received from the mobile device 104, the smart tag 108 may generate and transmit a TAC to the mobile device 104. This particular configuration does not result in the superfluous generation of TACs as compared to the first example described above.

Upon receiving the results from the cryptographic engine 148, the NFC applet 136 formats a response for the mobile device 104 that includes the tag data 140 as well as the results received from the cryptographic engine 148 (e.g., the TAC). The NFC applet 136 then prepares the data object to be provided to the mobile device 104. More particularly, the TAC may correspond to the response-specific data in the data object whereas the tag data 140 and TAGID 132 may correspond to the non-response-specific data. As a non-limiting example, the message transmitted back to the mobile device 104 may be formatted for transmission via NFC, Bluetooth, or some other proximity-based RF communication protocol. Even more specifically, the message transmitted back to the mobile device 104 may comprise one or more NDEF records having the tag data 140, TAGID 132, and TAC.

In some embodiments, the response provided back to the mobile device 104 from the smart tag 108 may be formatted as a URL with the tag data 140, TAGID 132, and TAC. In other embodiments, the response may be in the form of an email address, phone number, or the like that contains some or all of the tag data 140, TAGID 132, and TAC.

The tag data 140 may direct the communication application 124 of the mobile device 104 to communicate with the tag platform (or content server) 112. In particular, the response provided from the smart tag 108 to the mobile device 104 may correspond to a URL or the like. Upon receiving the response, the mobile device 104 may utilize the communication application 124 to request content (e.g., one or more web pages 152) from the tag platform 112. Even more specifically, the URL received from the smart tag 108 may correspond to an address of the web page(s) 152. Thus, the communication application 124 may attempt to retrieve the web page(s) 152 upon receiving the URL from the smart tag 108. As will be discussed in further detail herein, the response provided by the tag platform 112 may be dependent upon the mobile device 104 proving that it is within proximity to the smart tag 108 (e.g., it has the same location as the smart tag 108). In other words, the smart tag 108 is provided with the ability to respond to each read request in a substantially unique fashion, thereby prohibiting replays and copies of previous responses. If the mobile device 104 provides a valid and unique response to the tag platform 112, the tag platform 112 may provide the requested content. For instance, if the content provided by the tag platform 112 is sensitive and can only be viewed at certain locations, then the tag platform 112 will only provide the requested content if the mobile device 104 proves it is within a predetermined distance (e.g., a read range via communications channel 110) of the smart tag 108. Failure to make such a showing will result in the tag platform 112 denying the mobile device's 104 request for content.

Alternatively, or additionally, the tag platform 112 may select different content (e.g., web pages 152) for the mobile device 104 depending upon the determined presence of the mobile device 104. This may be done instead of simply denying content based on a replay or copy of a response. For instance, if the mobile device 104 is determined to be at a particular location (due to the mobile device 104 interacting with a particular smart tag 108 having a known and fixed location), then the tag platform 112 will provide appropriate content to the mobile device 104 based on its (and the smart tag's 108) location. If the mobile device 104 is determined to have a different location (e.g., due to interacting with a different smart tag 108), the tag platform 112 may provide different content back to the mobile device 104.

The authentication service 116 may be provided to help ensure that the mobile device 104 is at a particular predetermined location prior to the tag platform 112 providing requested content to the mobile device 104. As such, the authentication service 116 may comprise components that enable the authentication service 116 to analyze responses received at a mobile device 104 during a tag interaction to determine if the responses are unique or replays from previous tag interactions. In particular, the authentication service 116 may be provided with a TAGID repository 156 and a cryptographic engine 160.

The TAGID repository 156 may correspond to a data structure or listing of authentic and deployed smart tags 108 along with information about such tags 108. More specifically, the TAGID repository 156 may contain information that helps identify whether an interaction with a tag 108 corresponds to a unique interaction (e.g., TAC information, TAGID information, etc.). The TAGID repository 156 may also inherently contain or at least reference location information for deployed smart tags 108. In particular, when a smart tag 108 is deployed, the location information for the smart tag 108 may be stored within the TAGID repository 156 in association with the TAGID of the smart tag 108. In this way, the location information of each smart tag 108 can be known and whenever a mobile device 104 interacts with a smart tag 108, the location information for the smart tag 108 interacting with the mobile device 104 can be correlated with location information for the mobile device 104 due to the limited range of the communications channel 110.

The cryptographic engine 160 of the authentication service 116 may be similar or identical to the cryptographic engine 148 of the smart tag 108, thereby enabling the authentication service 116 to check TACs generated by the smart tag 108. More specifically, when the authentication service 116 receives information about a mobile device 104 interacting with a smart tag 108 (e.g., information contained in a tag response provided to the mobile device 104), the authentication service 116 may compare the TAGID received from the mobile device 104 to one or more TAGIDs contained in the TAGID repository 156 to determine whether the smart tag 108 that provided the response to the mobile device 104 is a valid and known smart tag. Additionally, the authentication service 116 may invoke its cryptographic engine 160 to generate an TAC based on its internally-maintained K and C values, which should match the K and C values of a valid smart tag 108. If the TAC generated by the cryptographic engine 160 matches the TAC received from the mobile device 104, then the authentication service 116 can verify that the interaction between the smart tag 108 and mobile device 104 was a unique interaction (e.g., there was no replay of a TAC by the mobile device 104). This information can be used to determine that the mobile device 104 is currently within read range of the smart tag 108 and, therefore, the location of the mobile device 104 can be correlated to the location of the smart tag 108. This correlation can be maintained within the TAGID repository 156 or within a presence database maintained by the tag platform (content server) 112. The newly-determined presence information for the mobile device 104 can also be used by the tag platform (content server) 112 to control the content provided to the mobile device 104. For instance, certain web page(s) 152 may be selectively provided to the mobile device 104 based on the determined location of the mobile device 104.

In some embodiments where the counter value C is incremented at the TAC module 144, the counter value C at the authentication service 116 is incremented for each response it receives for a particular smart tag 108. Thus, the counter values C at each node should maintain a certain amount of synchronization. Alternatively, where a pseudo-random number generator is used by the smart tag 108, a pseudo-random number generator may also be used at the authentication service 116. It should be appreciated that the authentication service 116 may be allowed to verify the validity of an TAC without necessarily generating its own TAC. Instead, the authentication service 116 may maintain a listing of previously-received TACs or counter values within the TAGID repository 156. This list may be kept indefinitely or it may comprise only a fixed number of TACs from previous interactions (e.g., the last 200 TACs generated by a particular smart tag 108). If the authentication service 116 receives an TAC that it has previously received (e.g., that is already found in the list of previously-received TACs), then the authentication service 116 may identify the TAC as invalid and may fail to correlate the location of the mobile device 104 to the smart tag 108.

Although the authentication service 116 is depicted as being separate and distinct from the tag platform (content server) 112 and discussions of the two components are primarily directed toward situations where different entities operate the components, such an implementation is not a requirement for embodiments of the present disclosure. To the contrary, the tag platform (content server) 112 and authentication service 116 may be administered by a common entity or enterprise without departing from the scope of the present disclosure. Additionally, although the TAGID repository 156 (and location information for smart tags 108) is depicted as being stored in the authentication service 116, it should be appreciated that the tag platform (content server) 112 may also maintain location information for tags 108 as well as correlated location information for mobile devices 104 that have interacted with tags 108.

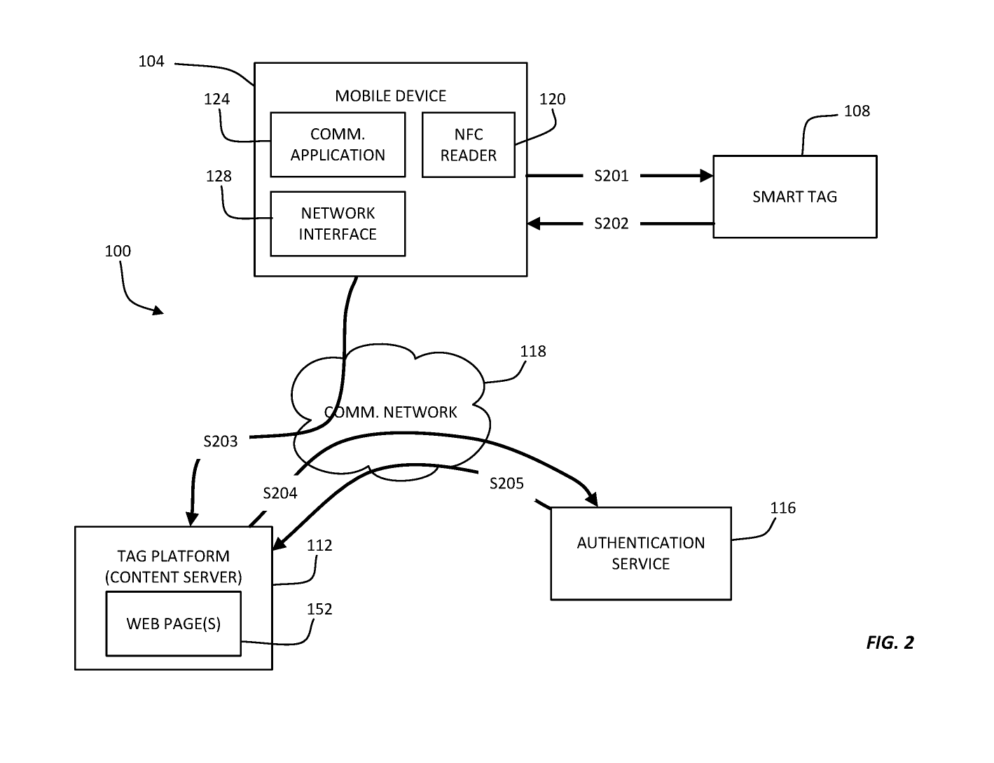

With reference now to FIG. 2, a first method of determining presence information for a mobile device 104 or a user/thing associated therewith will be described in accordance with at least some embodiments of the present disclosure. The method begins when the mobile device 104 transmits a read request to the smart tag 108 (step S201). The read request may be transmitted via the communications channel 110 and it may be transmitted before or after a mutual authentication has been performed between the mobile device 104 and smart tag 108.

Upon receiving the read request, the smart tag 108 generates a response thereto and transmits the response back to the mobile device 104 (step S202). The response may be transmitted back to the mobile device 104 via the same communications channel 110 over which the read request was transmitted. In some embodiments, both the read request and response may be transmitted over an NFC communications channel. Where NFC is used, some or all of the response may be transmitted in the form of one or more NDEF records. In some embodiments, both the read request and response may be transmitted using a Bluetooth or WiFi communications channel. Combinations of wireless channels may also be used without departing from the scope of the present disclosure. It should be appreciated that the response may include tag data (e.g., a URL, email address, phone number, etc.) or some other data that directs the mobile device 104 to the tag platform (content server) 112. The response may also include information that identifies the smart tag 108 (e.g., a TAGID) as well as interaction-specific information (e.g., an TAC). This information can be provided to the mobile device 104 in one or multiple messages.

In some embodiments, step S201 may be optional and the smart tag 108 may automatically generate a TAC in response to detecting the mobile device 104 within its read range. For instance, if the smart tag 108 detects the mobile device 104 as being within a Bluetooth read range (e.g., up to 100 feet), the smart tag 108 may automatically generate a new TAC. Upon a pairing between the mobile device 104 and smart tag 108, the smart tag 108 may send a data object to the mobile device 104 that includes the newly-generated TAC, a TAGID, and/or other information that is helpful in proving that the mobile device 104 is within the presence of the smart tag 108.

Upon receiving the data object from the smart tag 108 (e.g., in the form of a response or an initially-transmitted message), the mobile device 104 invokes its communication application 124 and issues a request for content to the tag platform (content server) 112 (step S203). In other embodiments, the mobile device 104 may simply send information received from the smart tag 108 to the tag platform 112 (e.g., without necessarily requesting content). Where the mobile device 104 is requesting content, for example by requesting one or more web page(s) 152 from the tag platform (content server) 112, the request may comprise one or more HTTP messages.

When the tag platform (content server) 112 receives the tag information from the mobile device 104, the tag platform (content server) 112 may request the authentication service 116 to confirm that the interaction between the mobile device 104 and smart tag 108 corresponds to a unique interaction (step S204). If the tag platform also implements the authentication service, then the request for confirmation may not necessarily need to traverse the communication network 118.

Upon receiving the information from the tag platform (content server) 112, the authentication service 116 may analyze the information provided from the smart tag 108 to the mobile device 104. In particular, the authentication service 116 may analyze the TAGID of the smart tag 108 as well as the TAC or interaction-specific information provided from the smart tag 108 to the mobile device 104. Based on this analysis, the authentication service 116 provides results of the analysis back to the tag platform (content server) 112, where the information is used to (i) update presence information for the mobile device 104 and/or (ii) condition whether and to what extent content (e.g., a web page 152) is provided to the mobile device 104 (step S205).

If the authentication service 116 verifies that the tag interaction was a unique interaction and the mobile device 104 is currently within a read range of the smart tag 108, then the tag platform (content server) 112 may correlate the location of the mobile device 104 with the known location of the smart tag 108. If the smart tag 108 has been fixed in a particular geographical location, then the mobile device 104 may have its location correlated to the particular geographical location of the smart tag 108. This correlation may occur within a data structure maintained by the tag platform (content server) 112 or within some other data structure (e.g., the TAGID repository 156), which may be maintained by the authentication service 116 or some other entity not depicted. In other embodiments, the location of the smart tag 108 may not actually correspond to a particular geographical location, but instead may correspond to an association of the smart tag 108 with another object. For instance, the smart tag 108 may be fixed or attached to a poster, a patient, a room in which a patient is sitting, a vehicle, a device to repair/control, a store, etc. When the mobile device 104 uniquely interacts with the smart tag 108, it can be confirmed that the mobile device 104 is within the presence of the object to which the smart tag 108 is attached or fixed if the interaction between the mobile device 104 and smart tag 108 is determined to be a unique interaction. Thus, the “location” of the mobile device 104 can be correlated with the object to which the smart tag 108 is attached or fixed rather than correlating the location of the mobile device 104 to a specific geographical location. In other words, the mobile device 104 can be determined to have been within the presence of the object to which the smart tag 108 is attached or fixed and this information may be maintained within a presence database or data structure. Moreover, the presence information can be determined to be current based on when the data object was received at the mobile device 104, based on when the mobile device 104 transmitted the request to the tag platform (content server) 112, or some other action that has a time stamp associated therewith.

As a more specific, but non-limiting example, the smart tag 108 may be incorporated into a wristband of a patient and a healthcare provider may use the mobile device 104 to read the smart tag 108 of the patient. When the mobile device 104/smart tag 108 interaction is determined to be unique, the location of the mobile device 104 and the healthcare provider can be correlated to the smart tag 108 and the patient, without necessarily considering the actual geographical location of the patient. As long as the mobile device 104 sends the unique information obtained from the smart tag 108 within a predetermined time window (e.g., an appointment window), it can be determined that the healthcare provider was in the presence of the patient at the required appointment window since the tag interaction cannot correspond to a replay of previous information obtained from the smart tag 108 earlier (e.g., from a site visit earlier in the day or in a previous day). This particular proof of presence solution is highly useful because many home healthcare providers have a need to verify that a clinician actually comes to a patient's house to provide the care that has been paid for. Methods used today to confirm such activity include the use of caller ID systems (e.g., a phone call placed from the residence of the patient to prove the clinician's presence as the residence) or GPS tracking of the clinician from a phone application. As land lines disappear and the GPS system does not provide enough granularity or non-repudiation, the disclosed proof of presence solution can be used to electronically verify that someone has visited the patient by having their mobile phone 104 interact with the smart tag 108 of a patient.

As another non-limiting example, a plurality of smart tags 108 may be attached to various checkpoints or rooms in a building to facilitate confirmation that a security guard is following a predetermined guard tour route, in the appropriate order, and at the appropriate times. A security guard may perform a guard tour of the building and during the tour be required to read each smart tag 108 with the mobile device 104. As the guard tour is performed, the movement of the guard within the building can be correlated to each smart tag 108 with which the guard uniquely interacts. If the guard properly follows the prescribed guard tour, the mobile device 104 will interact with the appropriate smart tags 108 in the appropriate order and this information can be confirmed by determining each tag interaction is unique and not a replay of a previous interaction from a previous tour. Moreover, if the guard is required to be at each location within a particular time window, the guard's compliance with the guard tour can be confirmed when the guard's mobile device 104 interacts with each smart tag 108 and the information obtained from each smart tag 108 is transmitted back to an authentication service. In some embodiments, the location of the mobile device 104 may be correlated to the location of each smart tag 108, which may correspond to the specific rooms or corridors within and around the building. Thus, a guard's compliance with a guard tour can be continuously confirmed in real-time. This provides particular advantages over prior art guard tour-compliance systems in that any type of mobile device 104 can be used by the guard as opposed to traditional, and more expensive, custom RFID readers. Secondly, the smart tags 108 themselves cannot be closed due to the keys used to generate the TACs.

Yet another non-limiting example is in the context of a sweepstakes/raffle/advertising campaign. Today, sweepstakes are typically managed by having a limited number of physical objects that are issued, for example a raffle ticket. An electronic version of a sweepstakes involves the user being directed to a website where the user is allowed to enter into the contest; however, anyone who knows the URL to the contest website could enter the content, which means that it is extremely difficult to limit the contest participants to only those people present at a particular location (e.g., a trade show, a conference, etc.). With the implementation of the proof of presence concepts disclosed herein, the entry into the sweepstakes/contest can be limited to only those people physically in the presence of the smart tag 108 (e.g., at the location where the entry must take place). Re-use of the URL through refresh or sharing will not result in a valid entry into the sweepstakes/contest.

Still another non-limiting example is in the context of loyalty discounts or coupons. Today, for example, loyalty credits (e.g., buy 10 sandwiches and get one free) are managed through physical punch cards that are modified every time a customer visits a store and makes a purchase. The electronic equivalent of this loyalty coupon involves having a user visit a web page that tracks a “virtual punch card.” However, by refreshing the browser or sharing the link, this system can be broken as well. Utilization of the proof of presence concepts disclosed herein helps the retailer ensure that the customer was physically present in the store when the customer received his or her additional loyalty points.

Although not depicted, the tag platform (content server) 112 may eventually provide content back to the mobile device 104. For instance, if the mobile device 104 issued a request for a web page, then the requested web page(s) 152 may be provided to the mobile device 104 where they can be displayed and presented to a user of the mobile device 104.

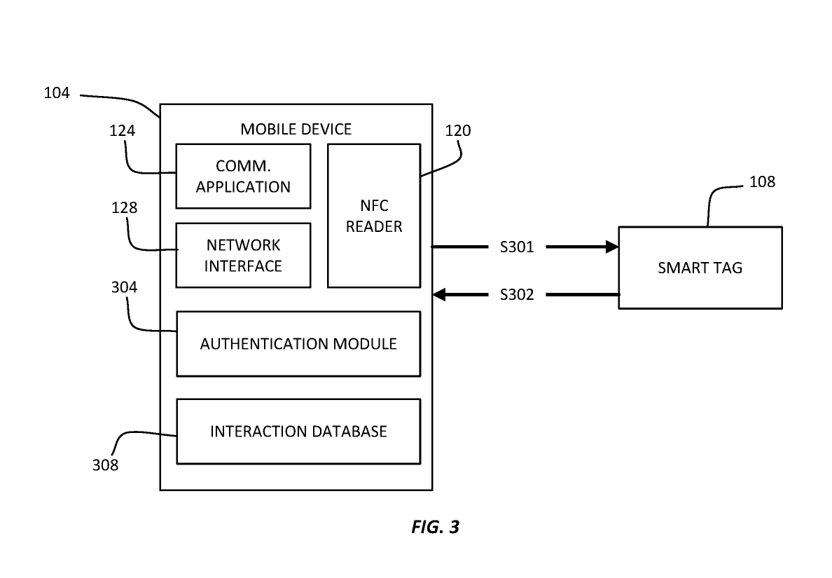

With reference now to FIG. 3, a second method of determining presence information for a mobile device 104 or a user/thing associated therewith will be described in accordance with at least some embodiments of the present disclosure. In this particular example, the mobile device 104 is provided with the ability to analyze tag responses to ensure such responses are unique. The mobile device 104 may also be provided with the ability to maintain information about its presence or a history of its tag interactions, which can eventually be correlated to location information.

More specifically, the mobile device 104 is provided with an authentication module 304 that enable the mobile device 104 to perform some or all of the functions discussed in connection with the authentication service 116. The mobile device 104 is also provided with an interaction database 308 that provides the mobile device 104 with the ability to historically track its tag interactions over time. Information from the interaction database 308 can be used by the mobile device 104 to ensure that it continues to have unique tag interactions. Furthermore, the interaction database 308 can be uploaded or provided to a third party, thereby enabling the third party to determine the mobile device's 104 movement over time based on its interaction history.

The method begins when the mobile device 104 issues a read request to the smart tag 108 (step S301). Similar to the read request issued in step S201, the read request issued in step S301 may be transmitted via the communications channel 110. The smart tag 108 may then respond to the read request with a response over the same communications channel 110 (step S302). In some embodiments, the response may contain information that identifies the smart tag 108 (e.g., the tag's TAGID) as well as information that is specific to the current interaction (e.g., a counter value, a TAC, etc.).

When the mobile device 104 receives the response, the mobile device 104 may compare the information contained in the response with some or all of the interactions stored in the interaction database 308. If the information from the current response does not exactly match information from any previous interactions, then the current interaction can be determined to be unique. At this point, the mobile device 104 may determine that it is interacting with a valid and authentic smart tag 108 and additional interactions may occur. Alternatively, or additionally, the mobile device 104 may update its own presence or location information and correlate such presence information with the smart tag 108. Again, the mobile device 104 may correlate its geographical location with a known geographical location of the smart tag 104 or the mobile device 104 may simply correlate its presence with an object to which the smart tag 108 is attached or fixed. This information can simply be maintained at the mobile device 104 and/or it can be reported to a third party, such as a tag platform (content server) 112 or authentication service 116.

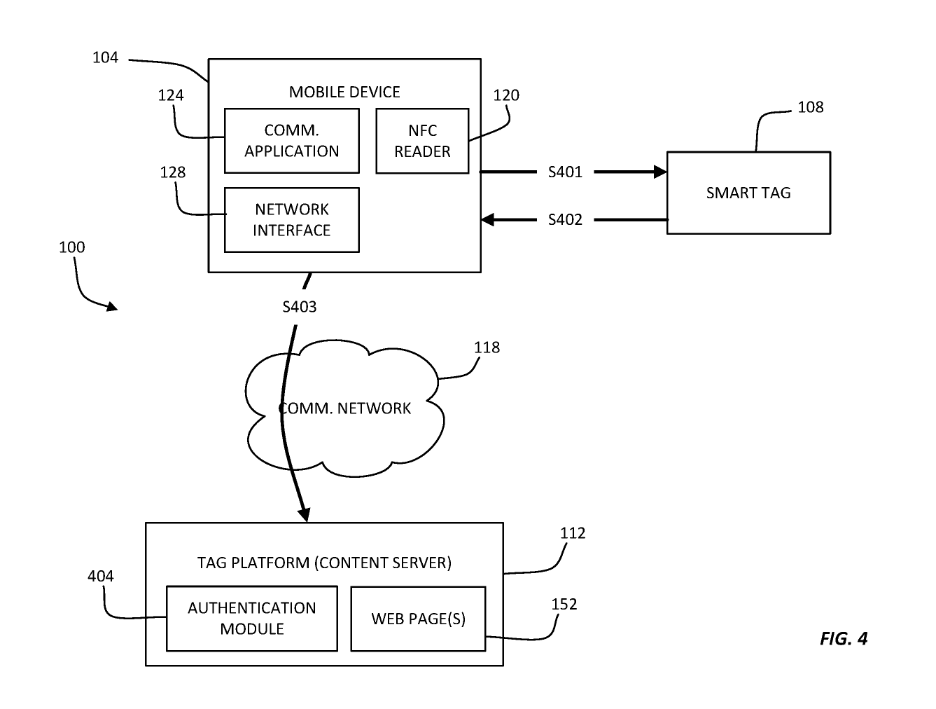

With reference now to FIG. 4, a third method of determining presence information will be described in accordance with at least some embodiments of the present disclosure. The method of this example shows a scenario where the tag platform (content server) 112 comprises the authentication module 404. More specifically, the tag platform (content server) 112 is enabled to inherently perform some or all functions of an authentication service 116 (e.g., to determine whether a tag interaction is a unique interaction).

The method begins with the mobile device 104 transmitting a read request to the smart tag 108 (step S401) and the smart tag 108 responding thereto (step S402). The read request and response may both be transmitted over the same communications channel 110 or different communications channels. Moreover, the response may include a TAGID 132, tag data 140, and/or a TAC generated by the smart tag 108.

Some or all of the response received at the mobile device 104 may be provided to the tag platform (content server) 112 via the communication network 118 (step S403). The tag platform (content server) 112 may then invoke its authentication module 404 to determine if the information provided from the smart tag 108 to the mobile device 104 was unique or not. In particular, the authentication module 404 may analyze the TAC and/or TAGID of the response to determine if the smart tag 108 provided a unique response to the mobile device 104, thereby proving that the mobile device 104 is within proximity of the smart tag 108. If the interaction is determined to be unique, then the tag platform (content server) 112 may correlate the location of the mobile device 104 with the location of the smart tag 108. This correlation may be maintained within a data structure of the tag platform or in an external presence database where it can be accessed by other servers and communication devices. The tag platform (content server) 112 may also decide to provide one or more web pages 152 to the mobile device 104 if the interaction is determined to be unique. The web page(s) 152 provided to the mobile device 104 may also vary depending upon the current geographical location of the smart tag 108 and/or the object to which the smart tag 108 is attached/fixed. Of course, if the interaction is not determined to be unique, then the location of the mobile device 104 may not be correlated with the location of the smart tag 108 and/or the web page(s) 152 may not be provided to the mobile device 104.

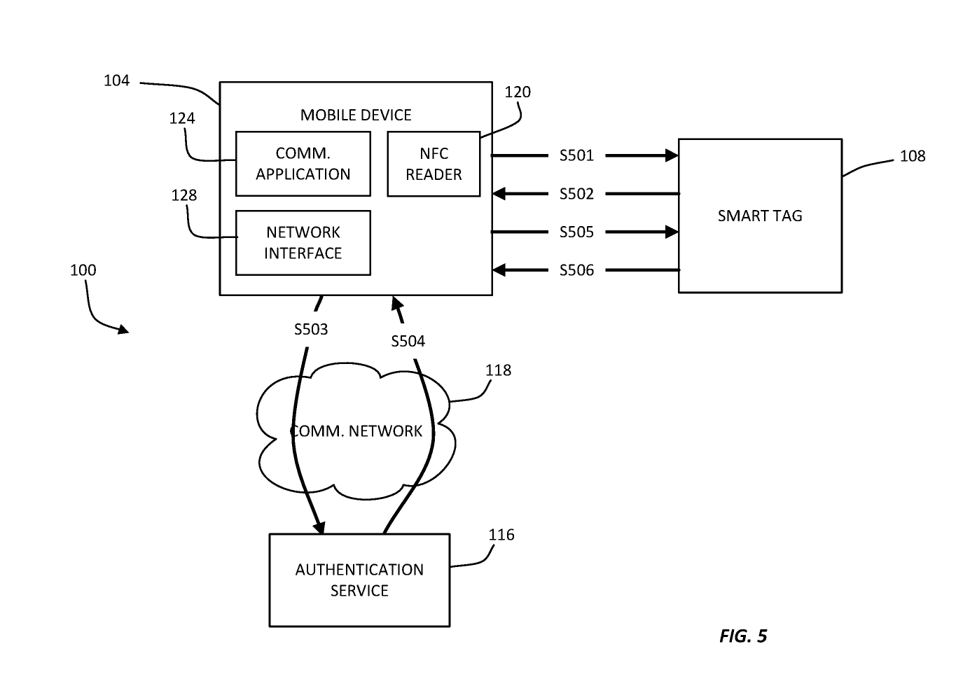

With reference now to FIG. 5, a fourth method of determining presence information will be described in accordance with at least some embodiments of the present disclosure. The method begins when a mobile device 104 transmits a first read request to a smart tag 108 (step S501). The first read request may correspond to an initial request for authentication information rather than a request for a full response containing tag data 140, a TAGID 132, and an TAC. In other words, the first request may correspond to a request issued before a level of trust has been established between the mobile device 104 and smart tag 108.

In response to the first request, the mobile device 104 may provide a first response (step S502). The first response may be enough information to allow the mobile device 104 to either authenticate the smart tag 108 or begin a process of authenticating the smart tag 108. Specifically, the first response may contain information that directs the mobile device 104 to an authentication service 116 to obtain a challenge/response pair (step S503). The authentication service 116 may determine an appropriate challenge/response pair based on the information contained in the first response of step S502. Once determined, the challenge/response pair is transmitted back to the mobile device 104 (step S504).

Upon receiving the challenge/response pair, the mobile device 104 may generate and send the smart tag 108 a second read request (step S505). The second read request may contain some or all of the challenge contained in the challenge/response pair issued by the authentication service 116. The smart tag 108 may analyze the second read request and generate a second response based on the information contained in the second read request. In particular, the information from the challenge may be used by the smart tag 108 to generate the second response, which is subsequently provided to the mobile device 104 (step S506). If the second response received from the smart tag matches the response from the challenge/response pair, then the mobile device 104 can determine that the smart tag 108 is a valid, authentic, and trusted smart tag. Alternatively, or additionally, the comparison of the second response issued in step S506 with the response from the challenge/response pair may be performed by the authentication service 116. As a further note, the read requests S501, S505 and responses S502, S506 may all be transmitted over a common communications channel 110 directly between the mobile device 104 and smart tag 108. Since there may be a lapse of time between the first read request and second read request, the user of the mobile device 104 may be required to hold the mobile device 104 within a read range of the smart tag 108 for a predetermined amount of time. The progress of the interaction can be depicted to a user of the mobile device 104 via a user output or display, thereby informing the user of how much more time is required for the user to hold the mobile device 104 within proximity of the smart tag 108.

The tapping, with a mobile device such as the mobile device 104, of a smart tag such as the smart tag 108 (e.g., placement of the mobile device within a predetermined proximity of the smart tag or vice versa, placement of the mobile device within an NFC read range of the smart tag or vice versa, placement of the mobile device within less than 50 cm of the smart tag or vice versa, etc.) helps to confirm intent to pay for the desired trip or load additional funds onto the mobile device, as explained in greater detail below, for a later trip. As also explained in greater detail below, these trusted tags can be positioned at one or many locations around a transport environment. In some embodiments, a smart tag/trusted tag solution can be easily installed wherever turnstiles are not used.

The use of trusted or smart tags in embodiments of the present disclosure helps to ensure no counterfeit receipts are created. If traditional NFC tags are used it would jeopardize the operator's income, and passengers could, without noticing, be charged by tags not belonging to the transport operator.

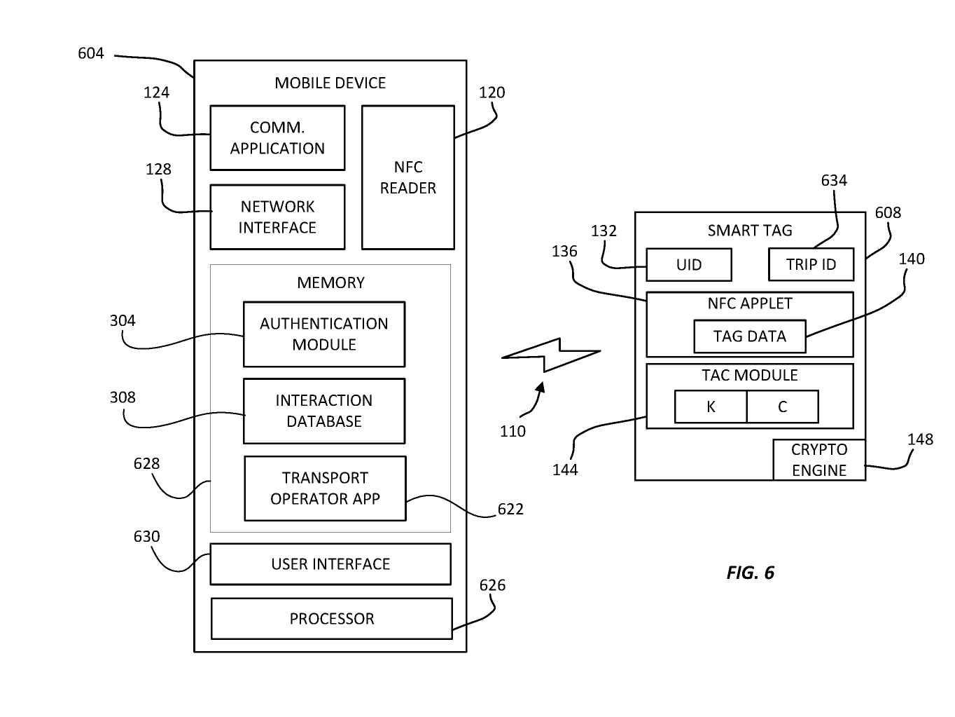

With reference now to FIG. 6, a mobile device 604 may comprise the same or similar components as the mobile device 104 described in the discussion of FIGS. 1-5 above. Like the mobile device 104, the mobile device 604 may comprise a processor, illustrated in FIG. 6 as the processor 626. The processor 626 may correspond to one or many microprocessors that are contained within the housing of the mobile device 604. In some embodiments, the processor 626 incorporates the functions of the user device's Central Processing Unit (CPU) on a single Integrated Circuit (IC) or a few IC chips. The processor 626 may be a multipurpose, programmable device that accepts digital data as input, processes the digital data according to instructions stored in its internal memory, and provides results as output. The processor 626 implements sequential digital logic as it has internal memory. As with most known microprocessors, the processor 626 may operate on numbers and symbols represented in the binary numeral system.

Also like the mobile device 104, the mobile device 604 may comprise a user interface, illustrated in FIG. 6 as the user interface 630. The user interface 630 may comprise one or more user input devices and/or one or more user output devices. Examples of suitable user input devices that may be included in the user interface 630 include, without limitation, buttons, keyboards, mouse, touch-sensitive surfaces, pen, camera, microphone, etc. Examples of suitable user output devices that may be included in the user interface 630 include, without limitation, display screens, touchscreens, and other output devices capable of displaying images. It should be appreciated that the user interface 630 may also include a combined user input and user output device, such as a touch-sensitive display or the like.

The mobile device 604 may also comprise a memory 628, in which the authentication module 304, the interaction database 308, and a transport operator application 628 may be stored. The memory 628 may be used in connection with the execution of application programming or instructions by the processor, and for the temporary or long term storage of program instructions and/or data. As examples, the memory 628 may comprise RAM, DRAM, SDRAM, or other solid state memory.

The mobile device 604 may also comprise a transport operator application 622. The transport operator app 622 may be stored in a memory of the mobile device 604. The transport operator app 622 may be a stand-alone app, or it may be an interface for facilitating interaction with the transport operator's website or other cloud-based services. The transport operator app 622 may comprise instructions for execution by the processor, which instructions cause the processor to implement at least a portion of the methods described herein.

The transport operator app 622 may be useful for several functions. In some embodiments, a user of the mobile device 604 may use the transport operator app 622 to purchase credit, which may then be exchanged for admission to one or more vehicles for one or more trips. For example, the transport operator app 622 may allow a user to select a desired amount of credit to purchase, provide payment information (e.g. credit card information, debit card information, or bank account information), review the proposed transaction (including the amount of credit to be purchased and the payment information), confirm the proposed transaction, and receive both an updated credit amount and a receipt for the transaction. The credit may be tracked as dollars, or it may be tracked in some other unit, which may have a predetermined dollar amount (e.g., credit may be tracked as tokens, each of which may be purchased for $0.25, or for $1.00, or for $5.00, or for any other amount). The credit may be tracked, stored, or otherwise associated with a vendor account (e.g. a user account with a vendor), with a broker account (e.g. a user account with a broker, such that the credit associated with the broker account may be used to purchase goods or services from more than one vendor), with another account associated with the transaction, or stored in memory of the mobile device.

In some embodiments, the transport operator app 622 may also be used to purchase a ticket or pay the fare for one or more trips. For example, the transport operator app 622 may allow a user to select a desired ticket or fare for which credit previously purchased by the user will be exchanged, review the proposed transaction (including the details of the ticket or fare and the amount of credit that will be exchanged for the ticket or fare), confirm the proposed transaction, and receive both an updated credit amount (e.g. reflecting a deduction of the amount of credits exchanged for the ticket or fare) and a receipt for the transaction. In some embodiments, the transport operator app 622 may allow users thereof to purchase electronic “ticket books” containing more than one ticket (e.g. ten tickets, thirty tickets) each redeemable for one trip or journey, or to purchase an electronic ticket that may be used an unlimited or a specified number of times each day for a given time period (e.g. a day, a week, a month, or some other time interval).

Also in some embodiments, the transport operator app 622 may be used to browse available tickets and fares. If the transport operator app 622 is provided by or in connection with a bus operator, for example, the transport operator app 622 may allow a user thereof to review bus schedules, different fare levels (e.g. local, regional, express), and special offerings (e.g. an airport bus, a ski bus, a special event bus). Similarly, if the transport operator app 622 corresponds to a train operator, then the transport operator app 622 may allow a user thereof to review train schedules, the fare for different types of train route (e.g. local, subway, commuter, interstate, transcontinental), fare levels for any particular train route (e.g. first class, coach, cabin), and special offerings (e.g. airport train, ski train, special event train).

While in some embodiments the transport operator app 622 may allow or require users thereof to purchase credit and/or tickets in advance, in some embodiments the transport operator app 622 may allow a user of the mobile device 604 to purchase (whether with previously purchased credits or with actual money, using, for example, a credit card, debit card, or electronic check) a ticket or pay the fare for a given trip by scanning a smart tag associated with the given trip (e.g. located at the check-in desk for the trip in question, or on the vehicle that will be making the trip in question) shortly before departing on the trip in question. For example, when the mobile device 604 scans a smart tag 608, the resulting communications between the mobile device 604 and the smart tag 608 may cause the transport operator app 622 to display, on a user interface of the mobile device 604 (e.g. a graphical user interface), an option to purchase the trip to which the smart tag corresponds. If the user of the mobile device 604 selects the option, then the transport operator app 622 may complete the purchase transaction (using either credits already purchased by the user or payment information provided by the user). In these embodiments, the communications between the mobile device 604 and the smart tag 608 allow the consumer to avoid searching for a particular ticket or fare to purchase, as the smart tag 608 provides necessary information about the trip to the mobile device 604, which may then present some or all of that information to the user.

In some embodiments, users of the transport operator app 622 may establish an account with the transport operator or with the transport operator app 622. The account may be secured by any means known in the art, and may be used for tracking the user's available credits, storing the user's payment information, maintaining purchased but as-yet-unused tickets or fares, storing a history of transactions (including, for example, credit purchases, ticket/fare purchases, and ticket/fare redemptions (e.g. uses of tickets/fares)), storing user preferences (e.g. the user's preferred fare class, preferred departure and/or arrival times), and identifying user trends and using the same to facilitate user interactions with the transport operator app 622 (e.g. if the user buys the same number of credits every month, pre-populating a credit amount field with the number in question; or providing pre-populated search options for commonly traveled routes). A user may also be able to use his or her account with the transport operator and/or transport operator app 622 to establish a subscription plan, whereby the same number of credits and/or the same tickets or fares are purchased on a recurring basis (e.g. every week, every month, every year, or at a custom interval).

As shown in FIG. 6, the mobile device 604 may communicate via a communication channel 110 with a smart tag 608. The smart tag 608 may include the same or similar components as the smart tag 108 as described in the discussion of FIGS. 1-5 above. The smart tag 608 may also comprise trip identification information 634, which may be communicated to the mobile device 604 via the communication channel 110 whether as part of or in addition to the other communications between the mobile device 604 and the smart tag 608 described above.

The trip identification information 634 may comprise, for example, one or more of a trip date, a departure location, a destination location, a time in route, a ticket cost (e.g. the number of credits required to purchase a ticket for the trip, or the actual dollar amount of a ticket for the trip), a cost of available upgraded tickets (e.g. a cost of a first class ticket), a number of total seats for the trip, and a number of remaining available seats for the trip.

In some embodiments, a smart tag 608 may be affixed to a transportation vehicle. The trip identification information 634 may then be updated as necessary to reflect each trip for which the transportation vehicle will be used. If the transportation vehicle will always be used for the same trip, and if the trip identification information 634 does not include any time-sensitive information (e.g. a trip date), then the trip identification information 634 of the smart tag 608 may not need to be updated for each trip. In other embodiments, the smart tag 608 may be affixed proximate to a gate or terminal of a transportation hub, in an area where passengers wishing to board a particular vehicle for a particular trip may congregate and/or await boarding, or in an area that passengers pass as they walk to the vehicle for boarding. In such embodiments, the trip identification information 634 may be updated as often as necessary to ensure that it reflects the proper trip.

Smart tags may also be placed in large population centers or in other locations that are conveniently or readily accessible to potential passengers. For example, one or more smart tags placed in the lobby of a hotel or a large office building may facilitate (and thus increase) the purchase of credits and/or of tickets by hotel guests or office building tenants.

In some embodiments, a smart tag 608's trip identification information 634 may comprise a number or code, or the smart tag 608 may not include separate trip identification information 634, but may use the TAGID 132 in place of the trip identification information 634. In these embodiments, the trip identification information 634 (or the TAGID 132) may be communicated to the mobile device 604, and a transport operator app 622 may input the trip identification information 634 or the TAGID 132 into a lookup function of a database (e.g. a database stored on the mobile device 604 (which may or may not receive periodic updates from the cloud), or a database maintained by or in connection with the transport operator and stored in the cloud) that correlates the trip identification information 634 or the TAGID 132 to actual trip information. The database may then return the actual trip information, which may be or include the same kinds of actual trip information identified above. In such embodiments, the trip identification information 634 (or the TAGID 132) need not be changed or updated when the smart tag 608 is used for different trips; instead, the database that correlates the trip identification information 634 to the actual trip information can be updated to reflect any changes in the actual trip information.

Although FIG. 6 only depicts the mobile device 604, the smart tag 608, and the communication channel 110, the mobile device 604 may communicate with one or more additional elements via a communication network 118 as described above with respect to FIGS. 1-5.

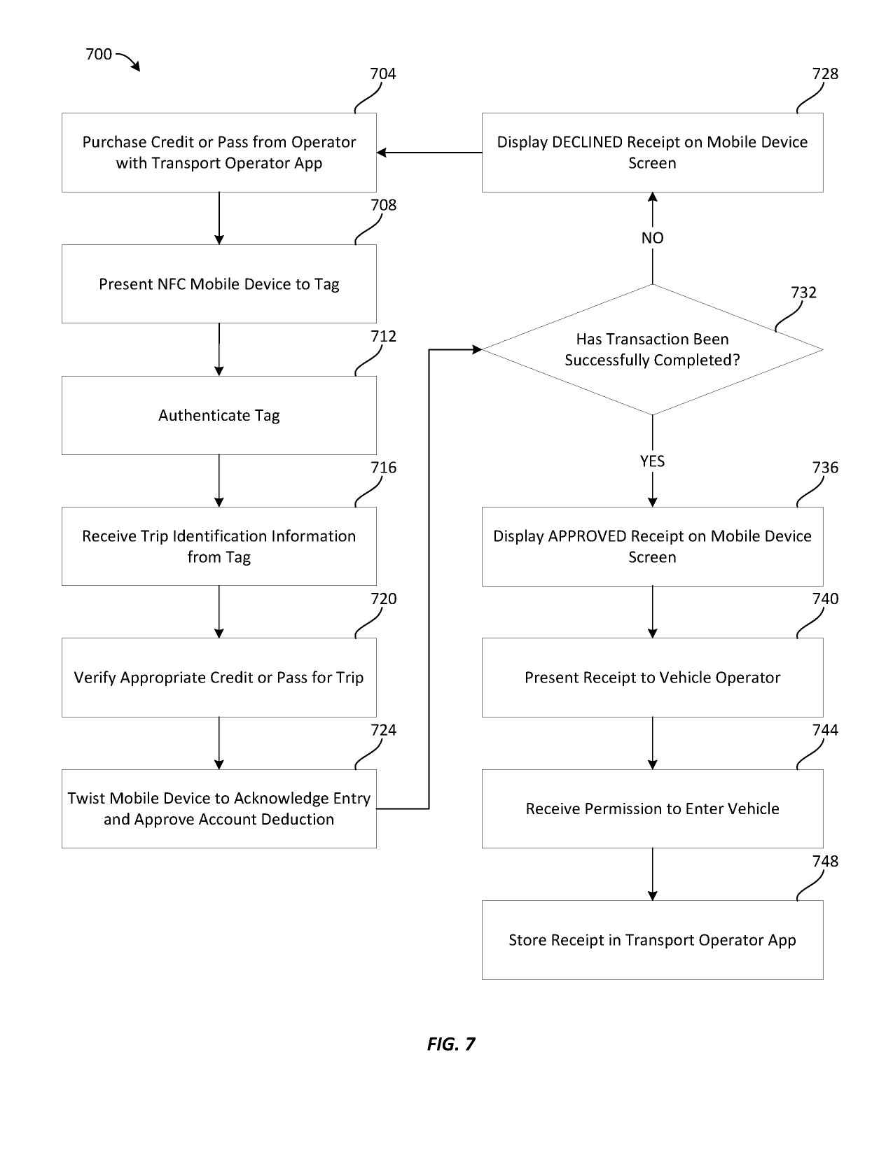

With reference now to FIG. 7, a method 700 may comprise purchasing credit or a pass from an operator with a transport operator app (step 704). The transport operator app may be an app such as the transport operator app 622, and the transport operator app may be installed on a mobile device such as the mobile device 604. The operator may be an entity that operates one or more transportation vehicles, or an agent or other representative of such an entity. The credit may be tracked and/or reflected as a dollar or other monetary amount (e.g. $5.00 of credit), or using non-monetary units (e.g. tokens, chips, or tickets). The pass may be a ticket for a specific trip (e.g. a flight from point A to point B), or a ticket that may be used on any trip of a particular type (e.g. a local bus ticket) or a ticket that may be used on any available trip. The operator may be any transport operator, including, for example, a bus operator, a rail operator (including a subway, light rail, commuter rail, train, and/or monorail operator), an airplane operator, a spaceflight operator, a taxi operator, or a boat operator.

The method 700 also comprises presenting an NFC mobile device to a smart tag (step 708). The NFC mobile device may be any mobile device having components similar to or the same as the mobile devices 104 and 604 described herein. In particular, the NFC mobile device comprises an NFC reader such as the NFC reader 120 for communicating with the smart tag. Presenting the NFC mobile device to the smart tag may comprise, for example, simply bringing the NFC mobile device within communication range of the smart tag, or tapping the NFC mobile device on the smart tag, or bringing the NFC mobile device within communication range of the smart tag and entering a command via a user interface of the NFC mobile device that causes the NFC mobile device to communicate with the smart tag. Presenting the NFC mobile device to the smart tag may trigger communications between the smart tag and the mobile device, including any of the communications between a smart tag and a mobile device described above.

The method 700 further comprises authenticating the smart tag (step 712). Authentication of the smart tag may be accomplished in any manner described above with respect to FIGS. 1-5. For example, authentication may comprise communicating with an authentication service 116, and/or may utilize an authentication module 304 or 404. Authentication may also comprise verifying the location of a mobile device relative to a smart tag or vice versa.

The method 700 may further comprise receiving trip identification information from the smart tag (step 716). The trip identification information may be received as part of or separately from the communications described above with respect to steps 708 and 712. The trip information may comprise trip identification information such as the trip identification information 634. Such information may include actual trip information. Alternatively, the trip information may comprise simply a number or a code that, once received from the smart tag, may be used to query a database and obtain actual trip information. The trip information may also comprise the smart tag's TAGID 132, which also may be used to query a database and obtain actual trip information. Actual trip information obtained using trip identification information may be or include any of the actual trip information described herein, including in particular information about the cost (whether in credit or in tickets/passes) of the trip with which the smart tag is associated.

The method 700 further comprises verifying that the user has the appropriate credit or pass for the trip (step 720). For example, the mobile device running the transport operator app (which, for example, may comprise instructions for execution by a processor) may compare the cost of the trip (whether in credits or in tickets/passes) with the amount of credit or tickets/passes currently held by the user (e.g. currently associated with the user's account, which may be an account with a vendor, a broker, or another entity). The mobile device or the transport operator app may provide the results of that comparison to the user via a user interface of the mobile device, or the mobile device may simply perform the verification automatically and without notification to the user (unless, for example, the verification is unsuccessful, and the user does not have sufficient credit or tickets/passes to obtain the ticket. Then, the mobile device or the transport operator app may alert the user that the verification was unsuccessful.

To confirm his or her intent to proceed with purchasing or redeeming a ticket for the trip associated with the smart tag in question, a user may twist the mobile device, complete another motion or predetermined sequence of motions, or provide some other predetermined confirmation input to the mobile device. The confirmation input may be one that a user can easily complete with one hand, to facilitate the user's providing the input at a time when the user is likely to be carrying one or more travel bags. The input may also be one that a user is unlikely to make unintentionally, to avoid the possibility of inadvertently providing confirmation to proceed with purchasing or redeeming a ticket for a given trip. Upon receipt or detection of the confirmation input, the mobile device (or a transport operator app running on the mobile device) may attempt to complete the ticket purchase/redemption transaction, which may involve communicating with a cloud-based service maintained by the transport operator. For example, the mobile device may transmit a purchase request to a cloud-based service requesting that pre-purchased credit associated with the user of the mobile device (e.g. associated with an account of the user with the cloud-based service) be exchanged for a ticket. As another example, the mobile device may transmit a ticket redemption request to a cloud-based service requesting that a previously purchased ticket associated with the user of the mobile device be exchanged for an authorization (e.g. a boarding pass) to board a vehicle that will make the trip for which the ticket was purchased. Systems and methods for securely completing purchase transactions from an app on a mobile device are known, and any suitable such system and method may be utilized for completing the transaction. A suitable system and method for completing the ticket purchase/redemption transaction is one that allows the user to securely exchange the necessary amount of credit for a ticket, and/or to exchange a ticket for a receipt or other authorization indicating that the user is authorized to take the trip in question, while creating a record of the transaction and ensuring that credit and ticket amounts associated with the transaction are properly updated. (For example, if a user exchanges five credits for a trip ticket, then a suitable system and/or method will ensure that the user's credit total reflects a deduction of five credits once the transaction has been completed, and that the user's trip ticket total reflects the purchased ticket.)

In step 732 of the method 700, the mobile device (running the transport operator app, which provides instructions executed by a processor of the mobile device) determines whether the ticket purchase/redemption transaction has been successfully completed. If not, then a DECLINED message is displayed on a user interface of the mobile device (step 728), thus alerting the user that the transaction failed. Assuming the transaction failed due to the user's insufficient credit or lack of a necessary ticket, the user may then return to step 704 to obtain the necessary credit or ticket and restart the method 700. In some embodiments, the transaction may fail for other reasons (e.g. lack of a suitable network connection), which, if known, may be displayed to the user via the user interface to assist the user in troubleshooting the problem.

If, however, the transaction is completed successfully, then the transport operator app may cause an APPROVED message or receipt to be displayed on a user interface of the mobile device (step 736). The user may then present this receipt (which may be, in some embodiments, a boarding pass) to the operator of the vehicle upon which the user will take the trip in question (or to any other individual responsible for allowing only authorized passengers to board the vehicle) (step 740), who may review the receipt to ensure that it appears to be authentic and, if so, grant the user permission to board (step 744). The receipt may also be stored in the transport operator app (e.g. stored in a memory of the mobile device and accessible through the transport operator app) for future retrieval and/or recordkeeping (step 748).

In addition to the security that use of the trusted tag/smart tag provides in terms of preventing counterfeit receipts, the visual receipt that is presented to the bus driver/conductor or other individual verifying that passengers are authorized to take a trip may have additional security in the background of the receipt, which may be updated according to a pre-determined scheme that is known to the bus driver/conductor or other individual. For example, the receipt may comprise one or more background colors, images, symbols, designs, or other security features that vary periodically according to a seemingly random, yet predetermined pattern. In some embodiments, as a further example, a background will shift every hour (or over non-uniform time periods) to a new image and this may be different for each bus/transport vehicle. Then, in addition to verifying that the receipt states APPROVED or otherwise indicates that the ticket purchase/redemption transaction was completed successfully, the individual checking the receipt can verify that the receipt includes the proper background security feature(s). In this way, the repeated use of a receipt may be prevented and the transport operator's revenue can be protected.

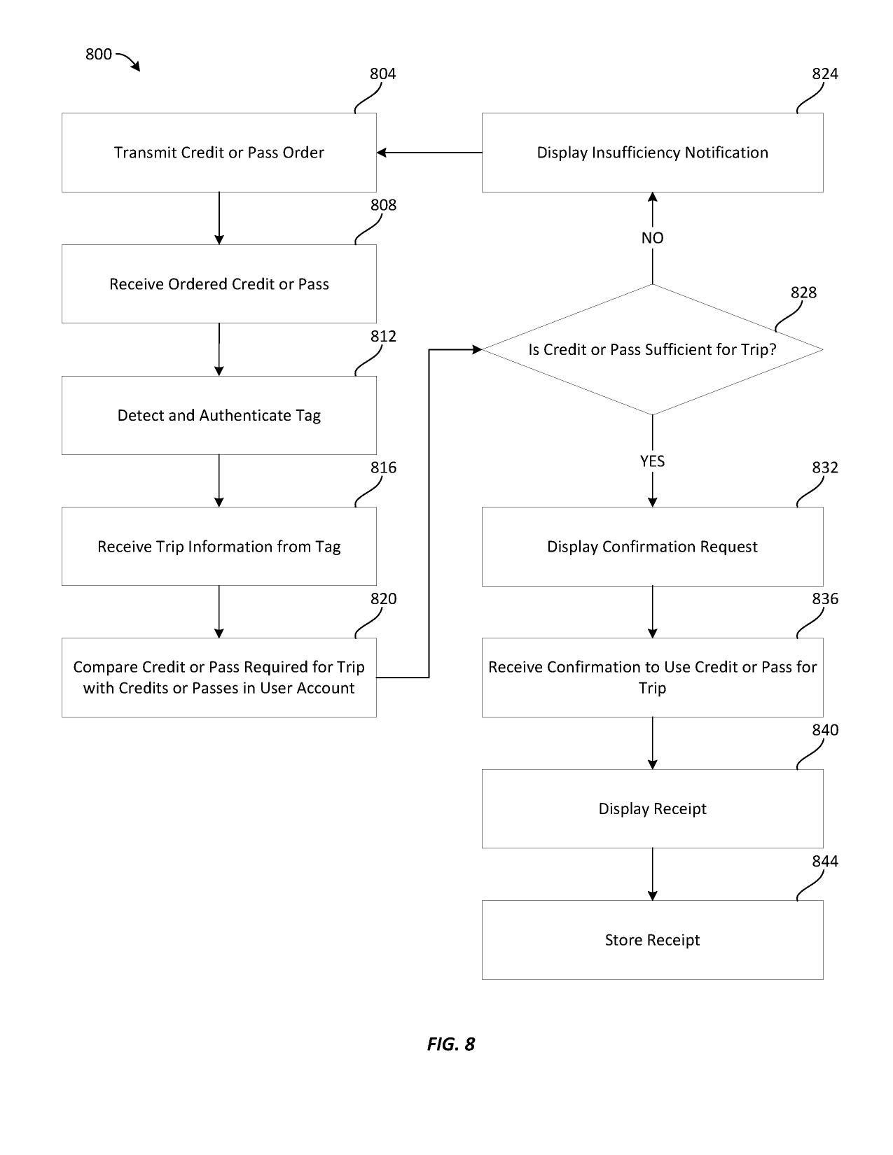

Turning now to FIG. 8, a method 800 according to another embodiment of the present disclosure comprises transmitting, from a mobile device, a credit or pass order (step 804). The mobile device may comprise a transport operator app stored in a memory thereof, and the transport operator app may comprise instructions that cause a processor of the mobile device to generate and transmit (via a network interface of the mobile device) the credit or pass order according to a specified format. The transmitted credit or pass order may include information about the number of credits or passes being ordered as well as payment information. The payment information may comprise, for example, credit card information, debit card information, electronic check information, or bank account information. Alternatively, for pass orders in particular, the payment information may comprise instructions to deduct the necessary number of credits from an account of the user ordering the pass.

The method 800 also comprises receiving the ordered credit or pass (step 808). The ordered credit or pass may be received by the mobile device via the network interface of the mobile device, and may comprise, for example, one or more digital certificates evidencing a transfer of the ordered credit or pass to the mobile device. Alternatively, receipt of the ordered credit or pass may comprise receiving, at the mobile device and via the network interface, an electronic message confirming that the ordered credit or pass has been added to or associated with the user's account. Upon receipt of the ordered credit or pass, the transport operator app may cause the mobile device to display an updated credit amount, the received pass, or any other confirmation that the ordered credit or pass has been received.

In a step 812 of the method 800, the mobile device detects and authenticates a smart tag. The detection may result from the user of the mobile device tapping the mobile device on the smart tag, or bringing the mobile device within communication range of the tag, or bringing the mobile device within a predetermined distance of the tag, or from the mobile device receiving a communication from the tag. Once the smart tag has been detected, the mobile device may authenticate the tag in any manner described herein, including by communicating with one or more of an authentication service 116 and an authentication module 304 or 404.

Whether as part of the authenticating the smart tag or separately, the mobile device receives trip information from the tag (step 816). The trip information may be a number or code, including a TAGID 132 and/or a number or code stored as trip identification information 634. In such embodiments, the mobile device may use the trip information from the tag to retrieve additional information, whether from a locally stored database or from a cloud-based service. For example, the mobile device may input the received trip information into the locally stored database or the cloud-based service, and may receive in return actual trip information, including any actual trip information described herein. In other embodiments, the mobile device may receive actual trip information directly from the tag, without needing to lookup any additional information using the trip information received from the tag.

In step 820, the mobile device compares the credit or pass required for the trip with the credits and/or passes in the user account that will be used to purchase the trip in question. This may require that the user of the mobile device logs into his or her account with the transport operator (or an authorized representative thereof) using the mobile device, although in some embodiments the user may already be logging into his or her account. In some embodiments, the user's account information may be stored on the mobile device, such that the mobile device need not obtain any account information from the cloud or elsewhere. In other embodiments, the user's account information may be stored in the cloud, and may only be accessible if the mobile device is able to access the cloud. Once the mobile device (or, more particularly, the transport operator app running on the mobile device) has access to the user's account information, the transport operator app can compare the amount of credit and/or other trip information about the trip associated with the smart tag with the amount of credit and/or the specific tickets or passes associated with the user's account to determine whether the user's account has the credits and/or ticket/pass necessary to purchase the trip.

The mobile device determines whether the user account has sufficient credits or tickets/passes for the trip in question at step 828. The determination is based on the comparison of step 820. As one example, if the trip in question requires 10 credits, and the user account only has 8 credits, then the mobile device may display, via a user interface thereof, an insufficiency notification (step 824). The insufficiency notification may invite the user to order more credits and/or the needed tickets/passes, and may provide a link to a credit/ticket/pass ordering screen or page. On the other hand, if the trip in question requires 8 credits, and the user account has 10 credits, the mobile device may display, via the user interface thereof, a confirmation request (step 832) that asks the user to provide a confirmation input to confirm that he or she would like to proceed with exchanging credit and/or a ticket/pass for the trip.

In response to the confirmation request, the user may provide an indication or input that acts as confirmation that the mobile device—and more particularly, the transport operator app—should proceed to exchange the appropriate number of credits/tickets/passes for the trip. Any suitable, known protocol for accomplishing electronic transactions may be utilized. The indication may comprise a twist of the mobile device or some other motion or sequence of motions (which may be detected, for example, by one or more accelerometers or other motion detectors within the mobile device). The indication may also comprise determining that an electronic button corresponding to a “Proceed” instruction has been pressed (e.g. on the user interface of the mobile device), or that some other predetermined input has been received.

Once the mobile device has received confirmation to proceed with exchanging the appropriate number of credits/tickets/passes for the trip in question, the mobile device completes the transaction and displays a receipt on a user interface thereof (step 840). The receipt may reflect, for example, that the appropriate number of credits has been deducted from the user account, or that the appropriate ticket/pass has been removed from the user account, and that the user is authorized to board the appropriate vehicle to take the trip in question. The receipt may be generated by the mobile device (including by the transport operator app running on the mobile device), or the receipt may be transmitted to the mobile device and received at the mobile device via a network interface thereof.

The mobile device may also store the receipt in a memory thereof, or cause the receipt to be stored in the cloud, for future examination. For example, if the mobile device completes the method 800 at a time and place other than near the vehicle taking the desired trip and at the time of boarding or shortly before, the receipt may be stored until the user of the mobile device needs to show the receipt to the transport operator or a representative thereof in order to gain access (e.g. to board) the appropriate vehicle.

While embodiments of the present disclosure have been described in connection with public transportation solutions, it should be appreciated that the claims are not so limited. To the contrary, embodiments of the present disclosure can be applied to virtually any ticketing implementation in general and could be applied to non-ticketing/non-event environments such as hotel environments, extended stay scenarios, corporate visitor scenarios, governmental visitor scenarios (e.g., temporary visas), etc. Furthermore, embodiments of the present disclosure should not be construed as being limited to transport ticketing environments. Indeed, embodiments of the present disclosure can be applied to any type of payment/receipt situation. For instance, the trusted tags described herein can be deployed in and/or around parking lots or parking structures and users of the parking lot and/or parking structure could simply tag their phone against the trusted tag to invoke a method whereby the user can complete payment for use of the parking lot and/or structure as well as receive a proof of purchase/receipt for the completed payment. To be clear, embodiments of the present disclosure can apply to any scenario where a user engages their mobile device with a trusted tag to pay for a good or service and then obtain a receipt for the same.

Thus, while specific details have been discussed in connection with journey information describing a route being traveled by the trusted tag, it should be appreciated that any service or goods information (which may include, for example, information about the cost of a given service or good) can be used to describe a service or good with which the trusted tag is associated. Moreover, instead of using a specified transport operator application to facilitate a transport-related transaction, any type of service or goods application can be used in connection with pre-paying a vendor for services and/or goods as well as conducting financial transactions with the vendor of the services and/or goods.

To avoid unnecessarily obscuring the present disclosure, the preceding description omits a number of known structures and devices. This omission is not to be construed as a limitation of the scopes of the claims. Specific details are set forth to provide an understanding of the present disclosure. It should, however, be appreciated that the present disclosure may be practiced in a variety of ways beyond the specific detail set forth herein. Moreover, it should be appreciated that the methods disclosed herein may be executed via a wearable device, a mobile device, another communication device, and/or a computing device.

Furthermore, while the exemplary aspects, embodiments, options, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a Personal Computer (PC), laptop, netbook, smart phone, Personal Digital Assistant (PDA), tablet, etc., or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

Optionally, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet other embodiments, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In other embodiments, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

Any of the steps, functions, and operations discussed herein can be performed continuously and automatically.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

What is claimed is:

1. A system, comprising:
a mobile device operated by a user; and
a trusted tag comprising:
memory that stores service or goods information describing a service or good with which the trusted tag is associated; and
a wireless interface that enables the trusted tag to communicate the service or goods information to the mobile device such that the mobile device is allowed to conduct a transaction using the service or goods information and obtain a proof-of-purchase for the service or good with which the trusted tag is associated.

2. The system of claim 1, further comprising:
a service or goods application stored on the mobile device that enables the mobile device to retrieve the service or goods information from the trusted tag and exchange credit for services or goods offered by a vendor.

3. The system of claim 2, wherein the service or goods application performs an authentication with the trusted tag prior to the trusted tag providing the service or goods information to the mobile device.

4. The system of claim 3, wherein the service or goods application requires the user to provide a confirmation of intent to complete the transaction prior to exchanging the pre-purchased credit for the services or goods offered by the vendor.

5. The system of claim 4, wherein the confirmation of intent comprises at least one predetermined motion or sequence of motions of the mobile device.

6. The system of claim 5, wherein the at least one predetermined motion or sequence of motions is sensed by the mobile device with an accelerometer provided on the mobile device.

7. The system of claim 2, wherein the credit is one of pre-purchased credit, credit card information and other payment information entered directly into the service or goods application.

8. The system of claim 2, wherein the service or goods application, after conducting the transaction with respect to the service or goods information, generates a receipt to provide the proof-of purchase.

9. The system of claim 8, wherein the receipt is visually displayed via a user interface of the mobile device.

10. The system of claim 9, wherein the receipt is stored in a memory of the mobile device.

11. The system of claim 1, wherein the trusted tag is associated with a vehicle, the service or good is a trip, the service or goods information comprises information about a cost of the trip, a date of the trip, a departure point of the trip, a destination of the trip, or a time in route of the trip, and the proof-of-purchase is one of a ticket or a boarding pass that provides authorization for boarding the vehicle for the trip.

12. A method of facilitating transactions and providing a proof-of-purchase for transactions, comprising:
presenting a mobile device to a trusted tag wherein the mobile device and trusted tag are within a wireless communication range of one another;
receiving, at the mobile device, service or goods information from the trusted tag, wherein the service or goods information describes a service or good with which the trusted tag is associated;
based on the service or goods information, determining whether an account associated with the user of the mobile device has sufficient credit to cover the service or goods associated with the trusted tag.

13. The method of claim 12, further comprising:
exchanging at least some of the credit in the vendor account for the service or good with which the trusted tag is associated.

14. The method of claim 13, further comprising:
after the exchanging, generating a receipt that constitutes proof-of-purchase of the service or good with which the trusted tag is associated.

15. The method of claim 14, further comprising:
displaying the receipt on a user interface of the mobile device.

16. The method of claim 14, further comprising:
storing the receipt in a memory of the mobile device.

17. The method of claim 12, further comprising:
displaying a request for confirmation to exchange at least some of the credit in the vendor account for the service or good with which the trusted tag is associated; and
receiving a confirmation input in response to the request.

18. The method of claim 17, wherein the confirmation input comprises a predetermined motion of the mobile device detected by an accelerometer of the mobile device.

19. The method of claim 12, wherein the service or good with which the trusted tag is associated is a trip and the service or goods information comprises information about the trip, the method further comprising:
exchanging at least some of the credit in the vendor account for a ticket to take the trip; and
displaying the ticket on a user interface of the mobile device.

20. A mobile device comprising:
a graphical user interface;
a network interface;
a near-field communication reader for communicating with a trusted tag;
a processor; and
a memory storing a transport operator application, the transport operator application comprising instructions for execution by the processor that, when executed by the processor, cause the processor to:
detect a trusted tag;
authenticate the trusted tag using authentication information received from the trusted tag;
receive trip information from the trusted tag, the trip information corresponding to a trip for which access may be purchased;
display, on the graphical user interface, a confirmation request;
receive a confirmation input;
in response to the confirmation input, transmit a purchase request to exchange pre-purchased credit for access to the trip;
receive, in response to the purchase request, a purchase receipt; and
display the purchase receipt on the graphical user interface.

21. The mobile device of claim 20, wherein the mobile device further comprises an accelerometer, and further wherein the confirmation input comprises a predetermined motion detected by the accelerometer.

22. The mobile device of claim 20, wherein access to the trip comprises a ticket, and wherein the trip information comprises a cost of the ticket, and further wherein the transport operator application comprises additional instructions that, when executed by the processor, further cause the processor to:
compare the cost of the ticket with an available amount of pre-purchased credit.
